(19) United States
(12) Patent Application Publication
(10) Pub. No.: US 2002/0173562 A1
(43) Pub. Date: Nov. 21, 2002

(54) Moisture curable grout polymer

(76) Inventor: Edwin S. Flores, Dallas, TX (US)

Correspondence Address: Sanford E. Warren, Jr., GARDERE WYNNE SEWELL LLP, Suite 3000, 1601 Elm Street, Dallas, TX, 75201, US

(21) Appl. No.: 09/827,196

(22) Filed: Apr. 5, 2001

(51) Int. Cl. C08K 3/00

(52) U.S. Cl. 524/2

(57) ABSTRACT

The present invention relates to a one-part adhesive, coating, or sealant composition that is useful to span gaps or crevices too wide for conventional grout and cement and which cures at ambient conditions upon application and exposure to moisture. More particularly, the invention pertains to such compositions containing moisture curable polymer precursors that exhibit excellent storage stability under anhydrous conditions and that cure with upon exposure to moisture.

### TECHNICAL FIELD OF THE INVENTION

The present invention relates to a structural composition that is useful to span gaps or crevices too wide for conventional grout and cement and which cures at ambient conditions upon application and exposure to moisture. More particularly, the invention pertains to compositions containing a cement to which moisture curable pre-polymer monomers are added under generally anhydrous conditions. The mixture cures upon exposure to moisture.

### BACKGROUND OF THE INVENTION

Without limiting the scope of the invention, its background is described in connection with construction and repair of bathrooms, as an example.

Grouts are widely used in the construction industry. The most commonly encountered grout is the thin mortar used to fill cracks and crevices in masonry. Grouts are used in common residential and commercial construction. These grouts generally include mortars of sand and cement. Where finer grouting is required, such as in decorative or waterproof tile installation, grouts composed of finer sands and plasters are used.

Ceramic flooring tiles are usually bonded to a variety of subfloors using bonding material, e.g., thin set mortar and grout. The term thin set mortar is used to describe the method of installing tiles with bonding material that is usually 3/32 of an inch to ⅛ of an inch in thickness. In larger installations, a mortar bed up to two inches in thickness is used to facilitate the creation of accurate slopes or planes in finished tile work on floors and walls. Portland Cement Mortar, a mixture of Portland cement and sand, is a suitable bonding material for most surfaces in ordinary types of installations. Portland Cement is the base for most grout and is modified to provide specific qualities such as whiteness, mildew resistance, uniformity, hardness, flexibility and water retentiveness. Non-cement based grouts such as epoxies, furans and silicone rubber offer properties not possible with cement grouts.

Floor tiles are typically installed such that a gap exists between adjacent tiles. While gap size varies depending upon the installation, ⅛ inch to ¼ inch gaps are typical. After the tiles are set and bonded by the mortar, grout must be applied and cleaned such that these gaps are filled. In some initial construction, but more commonly during repair, gaps are formed that are greater than ¼ inch. It has been found that gaps greater that ¼-inch exceed the strength and stability of commonly available grout. When grout is used to span large gaps the curing time of the grout increases dramatically. Furthermore, the grout within large gaps tends to sag during the curing process thereby requiring additional applications of grout and decrease longevity and reliability.

Conventional one-part urethane adhesive, coating, and sealant compositions generally include an isocyanate functionalized resins and crosslinkers or a combination of isocyanate functionalized and blocked amine functionalized compounds that are activated by moisture and/or heat. Conventional one-part urethane compositions generally contain significant amounts of organic solvents and/or plasticizers. The use of organic solvents and plasticizers, however, has certain disadvantages including longer drying time and escape of volatile organic pollutants into the atmosphere. The use of plasticizers also results in blooming and migration of the plasticizers onto surrounding materials. Another disadvantage of conventional moisture cure systems is the generation of a significant amount of gaseous molecules during the curing, particularly carbon dioxide. These gaseous molecules tend to agglomerate to form gas bubbles or voids that detrimentally affect the appearance and integrity of the cured sealant or adhesive compositions.

A two-part sealant composition comprising a first part containing a polyester or polyether oligomer having acetoacetate end groups or functionalities, and a second part containing amine end groups or functionalities is disclosed in U.S. Pat. No. 5,426,148. These compositions have the obvious disadvantage of requiring mixing or coapplication of the two parts at the point of application.

Compositions containing an acetoacetylated polymer or oligomer and polyamine crosslinking agents are described for example in U.S. Pat. No. 5,242,978. These compositions, however, have an extremely short pot life of about 30 minutes. Such compositions must be prepared at the point of application and must be used quickly after preparation. Accordingly, these curable compositions cannot be stored after preparation, tend to generate more waste because of premature curing of portions of the composition prior to application and hence are inconvenient.

Accordingly, there remains a need for a one-part, cement-based composition suitable for use as a grout, that quickly dries and cures at ambient conditions even in the presence of moisture. There is also a need for a grouting compound that is sufficiently strong to span large gaps between, e.g., adjacent tiles. Furthermore, a need has arisen for a composition that may be used to repair gaps or crevices that is resistant to moisture and water, that is easy to apply and costs effective.

### SUMMARY OF THE INVENTION

The present invention is a one-part, cement composition that includes polymer forming monomers. It has been discovered that such compositions, when prepared and maintained under substantially anhydrous conditions, exhibit excellent long-term shelf stability and exhibit relatively low inherent viscosity thereby reducing or eliminating the need for plasticizers and/or organic solvents.

The present invention, upon application and exposure to moisture at ambient conditions, quickly cures and dries to form a solid structural cement-polymer matrix. The cement-polymer matrix may have a sufficiently high solid content that enables crosslinking of both the monomers that form the structural matrix, but also the polymer matrix formed by the filler.

One example of a moisture curable polymer forming monomer is an acetoacetate functionalized polymer or oligomer. Other monomers for use with the invention may be isocyanate or other functionalized polymers or oligomers. The easy handling and application of the cement that includes polymers significantly reduces and eliminates the need for organic solvents or plasticizers. The reduction or absence of organic solvents leads to faster drying and curing time, and reduces pollution associated with the emission of volatile organic chemicals.

A wide variety of cure chemistries, catalysts and compositions may be used to facilitate rapid curing. One advantage is that only a catalyzing amount of moisture is needed to convert isocyanate groups of the polyisocyanate compound (crosslinker) into amine groups. Thereafter, the amine groups of the crosslinking compound readily reacts with the acetoacetyl groups of the polymer or oligomer via a condensation reaction that produces water which can react with more isocyanate groups thereby propagating the cure. In addition to facilitating rapid curing even in a low humidity environment, the cure chemistry of the composition also allows rapid curing of relatively thick applications of the composition to a substrate, because the moisture cure chemistry is not as dependent upon diffusion rates of moisture through the composition.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

### DETAILED DESCRIPTION OF THE INVENTION

While the making and using of various embodiments of the present invention are discussed in detail below, it should be appreciated that the present invention provides many applicable inventive concepts which may be embodied in a wide variety of specific contexts. The specific embodiments discussed herein are merely illustrative of specific ways to make and use the invention and do not delimit the scope of the invention.

Cement and Grouts

When used to fill cracks or holes in concrete, grout is generally a mixture of cement, sand or aggregate, and water. When used as a plaster, grout usually includes a mixture of cement, fibers, fine sand, water, and coloring material. When used as mortar for bricks, grout for use with the present invention may include a mixture of cement, sand, and even water, when used as part of a two-component system. Drywall applications, e.g., may use a grout that is a very fine, plastic-like material with little or no shrinkage upon drying for use in patching nail holes and joints in the drywall surface. Drywall grout also bonds a joint tape over to joints and in the corners of the drywall construction to provide a smooth, continuous wall surface.

For carpentry purposes, many procedures call for the application of a bead of adhesive laid along several studs, rafters or other longitudinal members prior to mounting a sheet of plywood, plaster board, or the like, thereto. The “grout” or filler of the present invention may even be sawdust or other cellulose based compounds. The filler may even be fibers of glass or other materials that may be used to form and modify the final polymer.

Construction workers often applies the grout for the particular construction activity by obtaining it from a bulk source such as a hopper or bucket, or in the case of adhesives, from a dispensing tube or cartridge. Regardless of the particular grout or its mode of application, the construction worker must take valuable work time prepare the grout and permit the grout to set. The worker must return periodically to the bulk supply of grout to replenish the on-hand supply of grout.

The present invention is based on the recognition that the addition of two essential ingredients, namely a filler or grout creating material, e.g., Portland cement and a moisture curable polymer may be stored in substantially anhydrous conditions and used, instantly by merely providing a free radical catalyst, e.g., water. The polymer-grout composition is capable of developing sufficient compressive strength and ideal setting characteristics that address the functional requirements of settings involving new construction or repair. Furthermore, the grout composition may include a significant proportion of Portland cement without affecting the performance of the grout composition.

Numerous additives, well known in the art, can be included in the grout composition for their known purposes. Such additives include anti-settling agents, humectants, pH control agents, biocides, freeze/thaw stabilizers, surfactants, fillers/extenders, drying rate controllers, defoamers, shrinkage controllers, anti-oxidants, UV-protectant and pigments.

Portland cement is made up of four main components: tricalcium silicate (3CaO SiO2), dicalcium silicate (2CaO SiO2), tricalcium aluminate (3CaO Al2O3), and a tetra-calcium aluminoferrite (4CaO Al2O3.Fe2O3). There are various types of Portland cement such as ordinary Portland cement and rapid hardening Portland cement and are well understood in the art. Generally, rapid hardening Portland cement differs from ordinary Portland cement in that it is more finely ground. Typically, ordinary Portland cement has a Blaine specific surface area of less than 3000 sq.cm./g whereas rapid hardening Portland cement has a Blaine specific area greater than 3000 sq.cm./g.

High alumina cement is a type of cement that is also well understood in the art. The principle cementing compound in high alumina cement is calcium aluminate (CaO.Al2O3). Gypsum (CaSO4 2 H2O) is a natural hydrated calcium sulphate. Calcined gypsum includes those forms of the gypsum that have been heated at atmospheric pressure to dry off at least a portion of the water of hydration and contain an average of between a half and zero molecules of water per molecule of calcium sulphate. Generally, normal calcined gypsum (also known in the art as .beta.-gypsum) is substantially composed of CaSO4 1/2H2O and anhydrous calcium sulphate. Hydrated calcium sulphate compounds are not suitable for use in the grout composition of the invention.

Examples of fillers or grouts for use with the present invention include anhydrous calcium sulphate can be used in the grout composition of the invention. Alpha.-Anhydrite and Beta-anhydrite are two crystalline types of anhydrous calcium sulphate and either of these types, or a mixture of both, that may be used alone or in combination. Small quantities of the hemi-hydrate or the dihydrate forms of calcium sulphate can of course be tolerated provided that the calcium sulphate that is used is substantially anhydrous calcium sulphate.

Moisture Curable Polymers

The acetoacetate functionalized polymers or oligomers (compound) that may be used in association with the compositions of the invention generally include any of a variety of well known polymers or oligomers having acetoacetyl functional groups. Examples of suitable acetoacetate functionalized polymers include acetoacetate functionalized acrylic polymers, acetoacetate functionalized polyesters, and acetoacetate functionalized polyethers, and other acetoacetate functionalized polymers or oligomers prepared by acetoacetylation of hydroxyfunctional polymers or oligomers. Acetoacetate functionalized polymers include polyesters and polyethers, with acetoacetate functionalized polyethers.

Acetoacetate functionalized polymers or oligomers may be prepared by acetoacetylation of polyhydroxy compounds with alkyl acetoacetates, diketene or other acetoacetylating compounds. Suitable polyhydroxy compounds include polyhydroxy polyesters, polyhydroxy polyethers and polyhydroxy polyacrylates.

Examples of polyhydroxy polyesters for use with the present invention include those having, e.g., a number average molecular weight of from about 500 to about 5,000, and in one embodiment from about 500 to about 3,000. The polyhydroxy polyesters may be prepared from condensation reactions of polybasic carboxylic acids or anhydrides and a stoichiometric excess of polyhydric alcohols, or from a mixture of polybasic carboxylic acids, monobasic carboxylic acids and polyhydric alcohols. Examples of polybasic carboxylic acids and anhydrides that may be used to prepare the polyhydroxy polyesters include those having from 2 to about 18 carbon atoms, and preferably having from 2 to about 10 carbon atoms, such as adipic acid, glutaric acid, succinic acid, malonic acid, pimelic acid, sebacic acid, suberic acid, azelaic acid, 1,4-cyclohexane dicarboxylic acid, phthalic acid, phthalic anhydride, isophthalic acid, terephthalic acid, tetrahydrophthalic acid, hexahydrophthalic acid, and the like, as well as combinations thereof.

One particularly useful group of compounds includes: malonic acid, tetrahydrophthalic acid, and hexahydropthalic acid. Monobasic carboxylic acids that may be used include, for example, those having from 1 to about 18 carbon atoms, and in some embodiments from 1 to about 10 carbon atoms, such as formic acid, acetic acid, propionic acid, butyric acid, valeric acid, caproic acid, caprylic acid, capric acid, lauric acid, myristic acid, palmitic acid, stearic acid, and the like, as well as combinations thereof. Suitable polyhydric alcohols that may be used include those having from 2 to about 18 carbon atoms, and e.g., about 2 to about 10 carbon atoms, such as ethylene glycol, propylene glycol, hexene-1,6-diol, trimethylol propane, glycerol, neopentyl glycol, pentaerythritol, butylene glycol, 2-methyl-1,3-propane diol, hexylene glycol, and the like, as well as combinations thereof. Particularly useful alcohols include trimethylpropane, glycol, and pentaerythritol.

Polyhydroxy polyethers that may be used with the present invention include those having a number average molecular weight of from about 500 to about 10,000, and from about 500 to about 6,000. The polyhydroxy polyethers may be prepared by well known ring-opening polymerization of cyclic ethers using an ionic initiator. Examples of polyhydroxy polyethers that may be used include those polyalkylene oxides where the alkylene group contains from 2 to about 8 carbon atoms. Polyalkylene oxides where the alkylene group contains from 2 to 4 carbon atoms, such as polyethylene oxide polyols, polypropylene oxide polyols, polybutylene oxide polyols, polytetramethylene oxide polyols, and the like may also be used.

Other polyhydroxy polymers or oligomers that be used include addition polymers, especially copolymers of acrylates and/or methacrylates, which are the reaction product of one or more alkyl acrylates and/or alkyl methacrylates, one or more unsaturated monomers containing a hydroxyl group, and, optionally, one or more other ethylenically unsaturated monomers which are free of hydroxyl or other residual functional groups. Such polymers may be prepared using conventional free radically initiated addition polymerization techniques. Examples of suitable acrylates and methacrylates include any of various acrylic acid esters and methacrylic acid esters wherein the ester portion has from 1 to 10 carbon atoms such as methyl methacrylate, methyl acrylate, ethyl acrylate, ethyl methacrylate, 2-ethyl hexyl acrylate, and the like.

Examples of other ethylenically unsaturated monomers that do not have hydroxyl functional groups such as vinyl substituted aromatics having from 8 to 12 carbon atoms include styrene, a-methyl styrene, vinyl toluene, and the like; nitrile monomers such as acrylonitrile and methacrylonitrile; vinyl acetate, ethylene, ethylene chloride, vinylidene chloride; etc. Examples of ethylenically unsaturated monomers containing a hydroxyl group include any of various hydroxyalkyl acrylates or methacrylates having a total of from 3 to 15 carbon atoms such as hydroxyethyl acrylate, hydroxyethyl methacrylate, hydroxypropyl acrylate, hydroxypropyl methacrylate, hydroxyhexyl acrylate, hydroxyhexyl methacrylate, and the like.

Still further examples of polyhydroxy polymers or oligomers that are suitable for use in the practice of the invention include hydroxyl-terminated copolymers of butadiene and acrylonitrile, such as HYCAR.RTM.HTBN, and hydroxy terminated organopoly-siloxanes, which are well known and are commercially available. Suitable polyhydroxy polymers or oligomers which can be used also include polytetrahydrofuran polyols, polycarbonate polyols, and caprolactone based polyols.

Suitable alkyl acetoacetates generally include those wherein the alkyl group R.sup.1 contains from about 2 to about 18 carbon atoms, and more preferably from about 2 to about 10 carbon atoms. Examples of alkyl acetoacetates include ethyl acetoacetate, n-propyl acetoacetate, isopropyl acetoacetate, n-butyl acetoacetate, isobutyl acetoacetate, tert-butyl acetoacetate, with tert-butyl acetoacetate being particularly useful because of its short reaction time and because the reaction may be easily driven toward completion by distilling off the tert-butanol that is formed during the reaction.

In accordance with another embodiment, the hydroxyl groups of the polyhydroxy polymers or oligomers are partially acetoacetylated such as to a level of less than about 70 percent, for example from about 10 to about 50 percent, acetoacetylation of the hydroxyl groups. The remaining hydroxyl groups are reacted with a polyisocyanate compound to provide polymers or oligomers that contains both acetoacetyl and isocyanate functional groups which can be combined with polyisocyanate compounds under anhydrous conditions to provide a moisture curable composition.

Polyisocyanate crosslinking and/or chain extension agents that may be used in the preparation of the one-part moisture curable grouting composition of the present invention include any of various polyisocyanate compounds containing two or more isocyanate groups, including simple compounds, as well as polyisocyanate functionalized polymers or oligomers (polymers). Examples of simple, non-polymeric polyisocyanate compounds include aliphatic, cycloaliphatic, aromatic, alkyl substituted aromatic, etc., polyisocyanates having a total of from about 5 to about 30 carbon atoms, such as trimethylene diisocyanate, tetramethylene diisocyanate, 2,3-butylene iisocyanate, hexamethylene diisocyanate, octamethylene diisocyanate, 2,2,4-trimethyl hexamethylene diisocyanate, 2,4,4-trimethyl hexamethylene diisocyanate, dodecamethylene diisocyanate, omega.,.omega.′-dipropyl ether diisocyanate, 1,3-cyclopentene diisocyanate, 1,2-cyclohexane diisocyanate, 1,4-cyclohexane diisocyanate, isophorone diisocyanate, 4-methyl-1,3-diisocyanatocyclohexane, dicyclohexylmethane-4-4′-diisocyanate, 3,3′-dimethyl-dicyclo-hexylmethane-4,4′diisocyanate, toluene diisocyanate, 1,3-bis(1-isocyanate-1-methylethyl)-benzene, 1,4-bis(1-isocyanate-1-methylethyl)benzene, 1,3-bis(isocyanatomethyl)benzene, xylylene diisocyanate, 1,5-dimethyl-2,4-bis(isocyanate-methyl) benzene, 1-5-dimethyl-2,4-bis-(isocyanato ethyl) benzene, 1,3,5-triethyl-2-4 bis(isocyanatomethyl)-benzene, 4,4′-diisocyanato diphenylmethane, 3,3′-dimethyl-4,4′diisocyanatodipheyl methane, various adducts of diisocyanates such as hexamethylene diisocyanate of isophorone diisocyanate, 1,3,5-triisocyanato benzene, 2,4,6-triisocyanato toluene, the tetraisocyanate adduct of pentaerythritol and toluene diisocyanate, and the like. Useful polyisocyanates include the various isomers of methylene diphenylene isocyanate (MDI) such as 4,4′-MDI and 2,4′-MDI.

Examples of suitable polymeric and oligomeric polyisocyanates include the reaction product of a polyhydroxy functional polymer, such as the polyhydroxy polyesters, polyhydroxy polyethers, and polyhydroxy addition polymers and oligomers described above, with a stoichiometric excess of a polyisocyanate such as those listed above. The isocyanate group to hydroxyl group ratio (NCO:OH) is desirably from about 2 to about 10, and more preferably from about 2 to about 4.

The moisture curable portion of the present composition may include any combination of di-, tri- and other polyacetoacetate and polyisocyanate functional compounds depending on the properties which are desired. Difunctional isocyanates and a combination of diols and triols are generally preferred, with the polyacetoacetate functional compounds having an average functionality of from about 1 to about 3, and preferably from about 1.2 to about 1.8.

In addition to the acetoacetylated polymers and/or oligomers, the composition can also include minor amounts of non-polymeric polyacetoacetates having a molecular weight in the range from about 200 to about 500 or 800. Examples of such compounds include the bisacetoacetates of dipropylene glycol, ethylene glycol and neopentyl glycol; the triacetoacetates of trimethylolpropane, trimethylolethane, glycerol and bis(trimethylolpropane); the tetrakis acetoacetate of pentaerythritol; and the like, as well as combinations thereof. Lower molecular weight polyacetoacetates may be used in the composition of the invention in minor amounts such as amounts that are effective to reduce the viscosity of the composition to a desired level. Generally, the lower molecular weight, non-polymeric polyacetoacetates may be present in amounts ranging from 0 up to about 30 or 40 weight percent based upon the weight of said compounds, the polyisocyanate functionalized polymers, and the various acetoacetate functionalized polymers or oligomers.

Polyacetoacetate functionalized polymers, oligomers, and non-polymeric (i.e., free of repeat units that form a backbone or chain) compounds are generally present in the composition in amounts relative to the amount of isocyanate group containing compounds such that the ratio of isocyanate functional groups to acetoacetyl functional groups is in the range of from about 10 to about 0.2, and with the range from about 3 to about 0.5 being particularly useful. The composition may contain any of a variety of different polyacetoacetate functional polymers or oligomers or combinations thereof, with polyacetoacetate functional polyethers being very useful.

The moisture curable monomers (or polymer) and the filler, grouting agent or compound are combined, along with other optional ingredients, under substantially anhydrous conditions and maintained in a sealed container until used. The one-part moisture curable compositions of the invention may be formulated for use as sealants, adhesives, or coatings, with a particularly well suited application of the invention being as a structural composition for filling gaps or crevices, e.g., during the construction or repair of bathrooms, sheet-rock, cement, fiberglass, baseboards, decks, roofs, and other applications in which a combination of strength and moisture resistance is desired.

The compositions of the invention can optionally include plasticizers such as dibutyl phthalate, butylbenzyl phthalate, and other phthalates; adipates, sebacate esters; benzoates; phosphates and the like, as well as combinations thereof. Plasticizers can generally be used at substantially lower levels in the composition of the invention than are currently used in conventional one-part moisture curable formulations to achieve the desired Theological properties. Generally, plasticizers are used, if at all, in amounts less than about 200 parts by weight per 100 parts by weight of the acetoacetate functional and isocyanate functional compounds.

The composition of the invention can optionally reduce viscosity to a desired level which facilitates easy application and use of the composition. Examples of organic solvents that may be used include aliphatic, cycloaliphatic and aromatic solvents such as hexane, cyclohexane, benzene, toluene, xylene, etc. These organic solvents are generally used in significantly smaller quantities than are required with conventional one-part moisture-curable compositions. Organic solvent, when used, are usually present in an amount less than about 10 parts, and more often less than about 5 parts, by weight per 100 parts by weight of the acetoacetate functional and isocyanate functional compounds. Often, no organic solvents are added except possibly those present as impurities in the other ingredients.

In order to accelerate the moisture cure upon exposure of the composition of the invention to ambient air, any of various known catalyst that promote reaction of the isocyanates groups with water to form primary amine groups and carbon dioxide can be added. Suitable catalysts generally include a variety of divalent tin catalysts such as stannous octoate, dioleate, palmitate, oxalate, acetate and the like. Such catalysts may be used in amounts effective to accelerate the cure, such as from about 0.005 to about 0.10 parts by weight per 100 parts by weight of the acetoacetate functional and isocyanate functional compounds.

The compositions of the invention can generally be formulated with a variety of conventional additives used in conventional amounts to achieve desired effects. Such additives include adhesion promoters such as polyisobutylene; driers and carbon dioxide absorbers such as calcium oxide; antioxidants such as combinations of hindered phenols and phosphate compounds; rheology modifiers; surfactants and or compatibilizing agents to help achieve a stable dispersion of the various ingredients in the composition; asphalt; carbon fillers; hydrocarbon resins; mineral fillers such as talc, clay, calcium carbonate, mica, and the like; reinforcing fibers such as KevlarTM. fibers, carbon fibers, ceramic fibers, polyethylene fibers, and the like; etc.

The composition of the invention generally have a high solids content such as at least 90 weight percent and more desirably at least 95 weight percent, and most preferably above 98 and 99 weight percent. Solids content as used above refers to the weight of the cured composition as a percentage of the weight of the material prior to curing.

The moisture curable grouting compositions of the invention should be carefully prepared under substantially anhydrous conditions, and placed in a sealed container in the absence of water until used. Care should be taken to ensure that any additives are substantially free of moisture prior to being added to the compositions of the invention. Procedures and precautions that are required to prepare and maintain the compositions of the invention under substantially anhydrous conditions are generally well known to those having ordinary skill in the art of preparing moisture curable adhesives, coatings and sealants. The compositions of the invention should generally contain less than 0.1%, and preferably less than 0.05% moisture on a weight basis.

The compositions can generally be formulated into a variety of adhesives, sealants or coatings which can be applied at ambient temperatures of from between about 35 to about 120 degrees F. (2 degrees C. to 49 degrees C.), and more in particularly useful embodiments at temperatures from between about 50 degrees to about 120 degrees F. (10 degrees C. to 49 degrees C.). The compositions will achieve a relatively fast cure rate even at low humidity conditions such as 1 or 2 percent.

Upon curing the compositions of the invention generally undergo random crosslinking and chain extension reactions wherein polyisocyanate groups that have been converted into primary amine groups by reaction with water can react either with other isocyanate groups or with acetoacetyl groups thereby forming a random cured polymeric structure which exhibit excellent tensile strength and tear strength. Likewise, the grout or other filler may also crosslink to provide dual strength to the filling material.

Color

Color may be added to the composition of the present invention. Examples of pigment additives for a number of colors are listed below with the weight percent of the specific pigments used with additive/silica sand.

| COLOR | ADDITIVE | WEIGHT % |
|---|---|---|
| Silver King Rutile | Titanium Dioxide | 4.17 |
| | Black Oxide | 0.42 |
| | Yellow Oxide | 0.08 |
| English Ivy | Titanium Dioxide | 4.25 |
| | Chromium Oxide | 1.25 |
| | Yellow Oxide | 0.50 |
| Wild Ginger | Red Oxide | 0.83 |
| | Black Oxide | 0.83 |
| Azalea Rutile | Titanium Dioxide | 4.17 |
| | Black Oxide | 0.17 |
| | Red Oxide | 0.83 |
| | Yellow Oxide | 0.67 |
| Wild Onion Rutile | Titanium Dioxide | 4.17 |
| | Yellow Oxide | 0.25 |
| | Red Oxide | 0.25 |
| | Black Oxide | 0.08 |
| Tulip | Red Oxide | 2.80 |
| | Bright Red | 3.33 |
| Bluebonnet Rutile | Titanium Dioxide | 0.83 |
| | Ultra Marine Blue | 6.42 |
| | Black Oxide | 0.83 |
| Sun Flower | Bright Yellow | 11.53 |
| Holly | Chromium Green | 14.78 |
| | Ultra Marine Blue | 8.87 |
| Honeysuckle | Titanium Dioxide | 4.17 |
| | Yellow Oxide | 0.42 |
| Arrowwood | Black Oxide | 0.58 |
| | Titanium Dioxide | 0.08 |
| Buckwheat | Titanium Dioxide | 4.17 |
| | Yellow Oxide | 0.92 |
| | Burnt Umber | 0.17 |
| | Black Oxide | 0.17 |
| Cattail Rutile | Titanium Dioxide | 1.25 |
| | Burnt Umber | 1.75 |
| | Black Oxide | 0.17 |
| Chocolate Lily | Black Oxide | 1.75 |
| | Burnt Umber | 1.25 |
| | Titanium Dioxide | 2.58 |
| Black Orchid | Carbon Black | 4.25 |

The industry standards for the foregoing color pigments are listed in the following table:

Color Index Numbers

Red Oxide=C.I. Pigment Red 101, C.I. No. 77491

Yellow Oxide=C.I. Pigment Yellow 42, C.I. No. 77492

Black Oxide=C.I. Pigment Black 11, C.I. No. 77499

Chromium Oxide=C.I. Pigment Green 17, C.I. No. 77288

Ultra Marine Blue=C.I. Pigment Blue 29, C.I. No. 77007

Carbon Black=C.I. Pigment Black 7, C.I. No. 77266

Bright Red=C.I. Pigment Red 170, C.I. No. 12475

Bright Yellow=C.I. Pigment Yellow 53, C.I. No. 77788

Burnt Umber=C.I. Pigment Brown 7, C.I. No. 77499

Titanium Oxide=C.I. Pigment White 6, C.I. No. 77891

Other variations to the above described invention will make themselves apparent to one skilled in the art. For example, the colors of the subparts can be any colors that may be combined to make a variety of color shades. Also, there can be more than two subparts comprising the second part of the system. The system may, alternatively, have a first part having subparts including the resin and the color pigment additives, or as another alternative can have three components wherein the first part includes the resin, the second part includes the hardener and the third part includes subparts including the filler and the color pigment additives.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A grout composition that sets after being mixed with water comprising:
an anhydrous structural filler that comprises between 10 and 90% by weight of the total grout composition; and
a moisture curable polymer.

2. The grout composition of claim 1 which further comprises an effective amount of a retarding agent to provide a retarding effect on the setting of the grout composition.

3. The grout composition of claim 1 wherein the anhydrous filler comprises Portland cement.

4. The grout composition of claim 3 wherein the Portland cement is rapid hardening Portland cement.

5. The grout composition of claim 1 wherein the Portland cement comprises between 30 and 55% by weight of the total grout composition.

6. The grout composition of claim 1 further comprising a color.

7. The grout composition of claim 1 further comprising a stabilizer.

8. The grout composition of claim 1 further comprising a rheolgical agent.

9. The grout composition of claim 1 further comprising a plasticizer.

10. The grout composition of claim 1 wherein the moisture curable polymer is selected from the group consisting of polyacetoacetate, polyisocyanates and mixtures thereof.

11. A moisture curable grout kit comprising:
a container comprising a moisture curable compound; and
a contained comprising a structural filler.

12. The kit of claim 11 wherein the structural filler further comprises moisture.

13. The kit of claim 11 further comprising an effective amount of a retarding agent to provide a retarding effect on the setting of the grout composition.

14. The kit of claim 11 wherein the anhydrous filler comprises Portland cement.

15. The kit of claim 11 wherein the structural filler is rapid hardening Portland cement.

16. The kit of claim 11 wherein the Portland cement comprises between 30 and 55% by weight of the total grout composition.

17. The kit of claim 11 further comprising a color.

18. The kit of claim 11 further comprising a stabilizer.

19. The kit of claim 11 further comprising a rheolgical agent.

20. The kit of claim 11 further comprising a plasticizer.

21. The kit of claim 11 wherein the moisture curable polymer is selected from the group consisting of polyacetoacetate, polyisocyanates and mixtures thereof.

22. A method of filling a gap or crevice comprising:
providing a moisture curable compound; and
adding to the moisture curable compound a structural filler, wherein upon exposure to water, the moisture curable filler forms a polymeric matrix along with the structural filler to fill the gap or crevice.
